(19) United States
(12) Patent Application Publication
(10) Pub. No.: US 2017/0027024 A1
(43) Pub. Date: Jan. 26, 2017

(54) HEATING PANEL AND SYSTEM

(71) Applicant: Kolls A. Oloko, Braintree, MA (US)

(72) Inventor: Kolls A. Oloko, Braintree, MA (US)

(21) Appl. No.: 15/199,099

(22) Filed: Jun. 30, 2016

Related U.S. Application Data
(60) Provisional application No. 62/194,528, filed on Jul. 20, 2015.

(51) Int. Cl. H05B 3/36

(52) U.S. Cl. CPC H05B 3/36

(57) ABSTRACT

A rubberized heating fabric composite, used to melt snow and used to dissipate cold draft. The system is a more targeted, proactive system that prepares the solution before the problem is created. This creates a more efficient and sophisticated solution to the age old problem of snow removal and cold drafts in general.

### CROSS-REFERENCE TO RELATED APPLICATION

This application claims the benefit of priority of U.S. provisional application No. 62/194,528, filed Jul. 20, 2015, the contents of which are herein incorporated by reference.

### BACKGROUND OF THE INVENTION

The present invention relates to heating elements, and more particularly to heating elements to prevent or alleviate the accumulation of snow and ice.

The present invention solves snow and ice removal and cold draft issues in an unconventional way. Existing methods of snow removal employ manual labor which is subject to time inefficiencies, injury prone, reactive, and other inefficiencies as opposed to proactive efficiencies.

The present system is a more targeted, proactive system for snow and ice removal that prepares the solution before the problem is created. This creates a more efficient and sophisticated solution to the age old problem of snow removal and cold drafts in general.

### SUMMARY OF THE INVENTION

These and other features, aspects and advantages of the present invention will become better understood with reference to the following drawings, description and claims.

### BRIEF DESCRIPTION OF THE DRAWINGS

FIG. 1 is a perspective view of a plurality of interconnected rubberized heating panels according to aspects of the present invention.

FIG. 2 is a top plan view of a rubberized heating panel element with parts broken away.

FIG. 3 is a cross-sectional view of an interconnected rubberized heating panels taken on line 3-3 of FIG. 1.

FIG. 4 is an exploded cross-sectional view of the interconnecting components of FIG. 3.

FIG. 5 is a schematic block diagram of a heating panel circuit according to aspects of the invention.

FIG. 6 is a front perspective view of an application of the rubberized heating panels with a parking lot and shown in a retracted condition.

FIG. 7 is a top perspective view of the application with a parking lot shown in a partially extended condition.

FIG. 8 is a side elevation view of the invention applied to use with a parking lot.

FIG. 9 is a first end elevation view of an internal drive roller mechanism.

FIG. 10 is a front elevational view of an internal drive roller mechanism.

FIG. 11 is a second end elevation view of an internal drive roller mechanism.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a heating panel and a heating panel system which is adapted for preventing or alleviating snow and ice removal from a variety of outdoor structures.

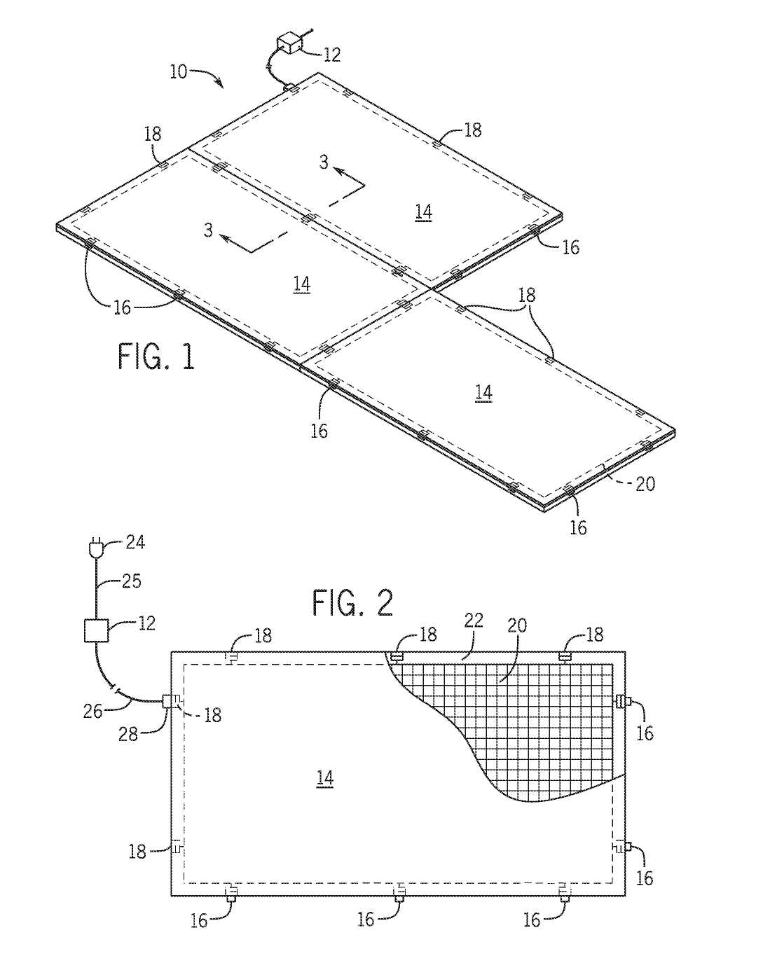

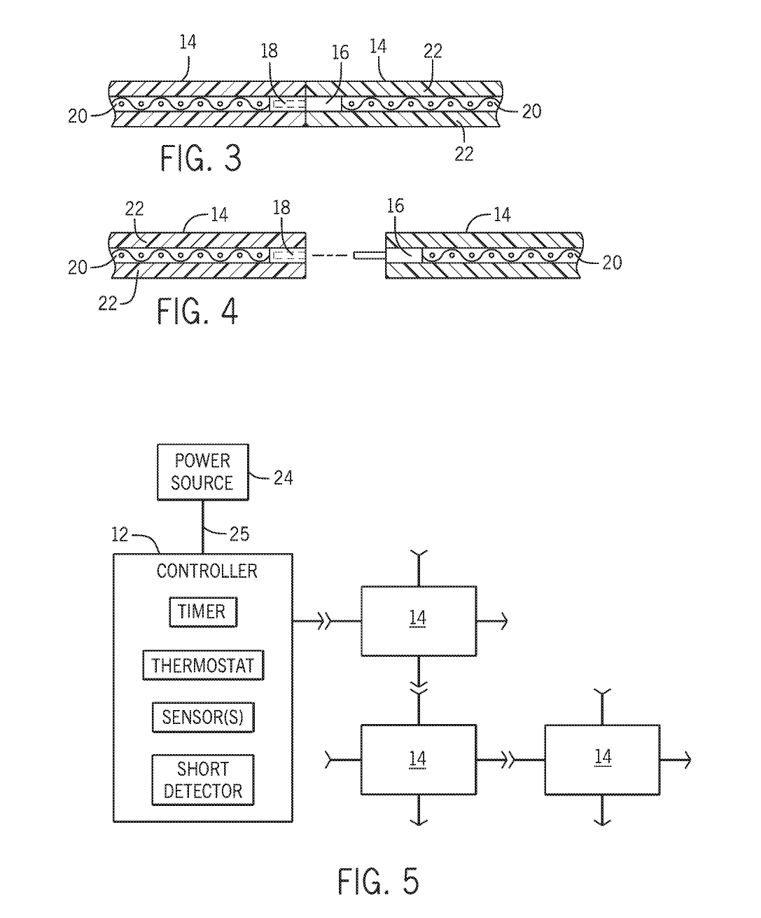

As seen in reference to FIGS. 1-4, a heating panel system 10 according to aspects of the present invention includes one or more heating panels 14 operatively connected to a controller 12. The heating panels 12 receive a current source from the controller 12 via a conductor attached to one or more connectors 16 & 18. The connectors 16 & 18 may be configured as a cooperating male 16 and female 18 connectors. The connectors 16 & 18 may, by way of non-limiting example, be universal serial bus (USB) connectors.

The heating panel 14 includes an electrically conductive mesh layer 20, formed of a metallic conductive yarn. The mesh layer 20 is covered on a front and back surface by a flexible thermally conductive material, such as a rubberized covering layer 22. The heating panel 14 may be formed in any shape, but is preferably formed as a rectangular sheet.

A plurality of connectors 16 & 18 are integrally formed in the rubberized layer 22 around a peripheral edge of the panel 14 and are in electrical communication with the conductive mesh 20. Female connectors 18 may be formed along a first and second adjacent edge in a spaced apart relation. The male connectors 16 may be formed along a third and fourth adjacent edge in a matching spaced apart relation to the female connectors 18. The connectors are disposed at positions along their respective edge surfaces such that a first panel 14 may be conductively interconnected with a second panel 14 via the cooperating male 16 and female 18 connectors. The first panel 14 may then communicate the electrical current from the power source to the second panel 14 via the mesh layer 22.

The controller 12 is connected to a power source via a power cable 25 and a conventional wall outlet plug 24. As seen in reference to FIG. 5, the controller 12 may include circuitry for a timer, a thermostat, one or more sensors, such as an ambient temperature sensor, precipitation sensor, and the like. The controller 12 may also include a short detector in the event the connectors 16 & 18, or a mesh layer 20 becomes electrically shorted. The controller 12 may be configured to produce and distribute heat to specific areas or panels 14 within an interconnected grouping of panels. The circuitry in the controller 12 provides an electrical current to panels 14 so that the panels 14 develop sufficient heat to melt the snow at the inception of a snow fall condition until the end of the snow fall leaving no frozen precipitation to clear from a protected surface.

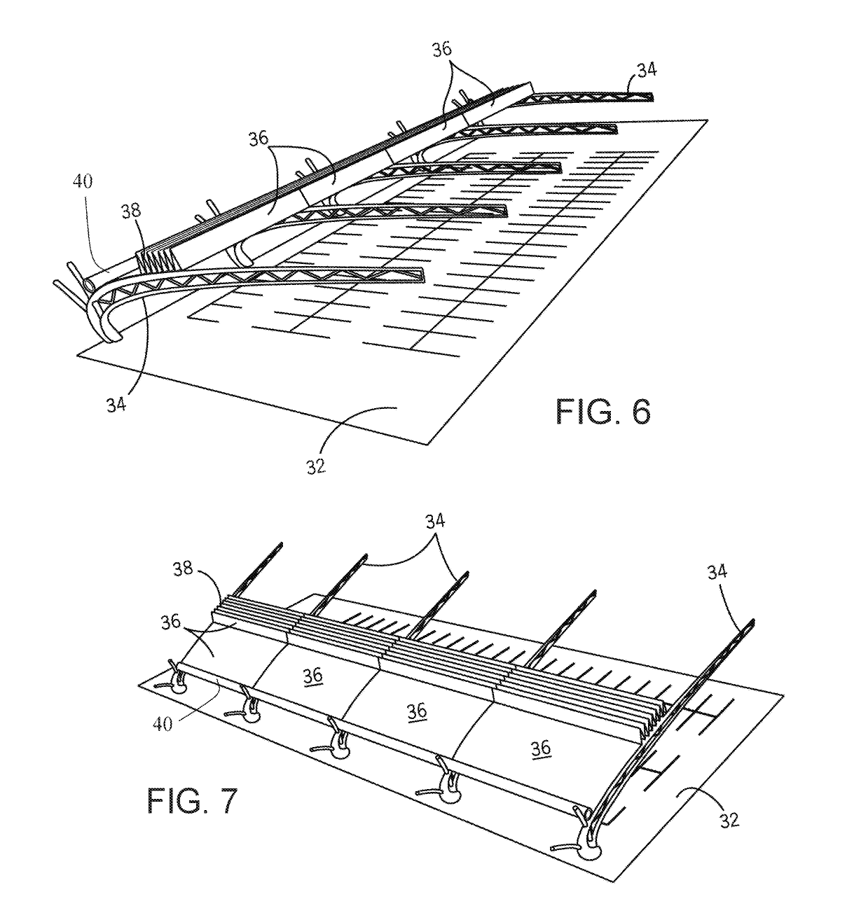

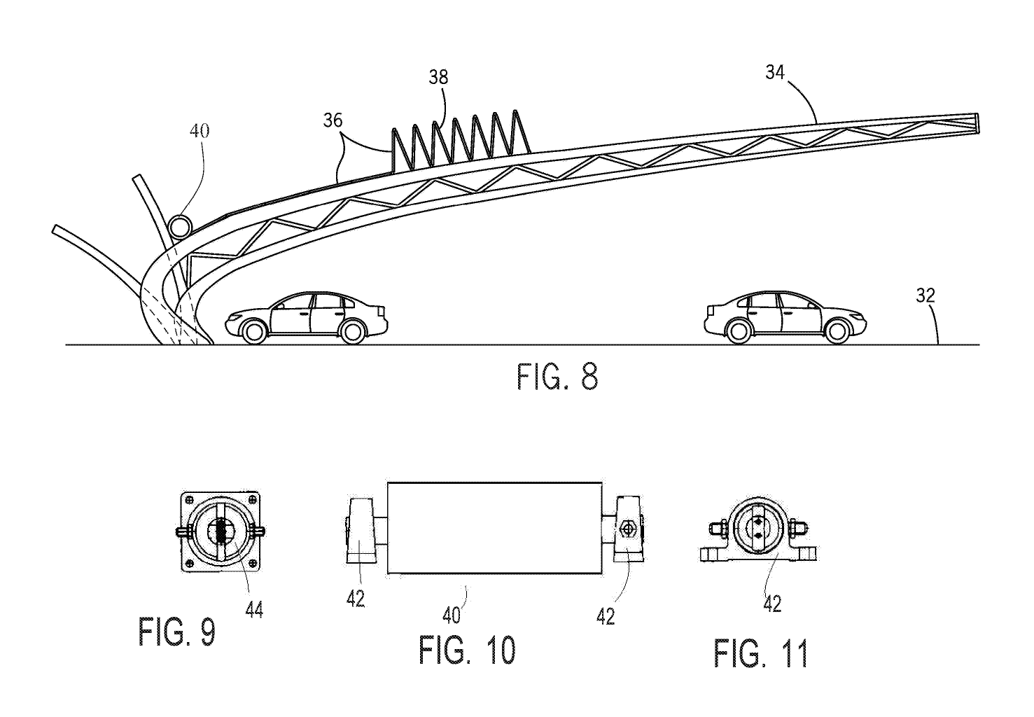

As seen in reference to FIGS. 6-8, the panels 14 may be configured to provide protection to a structure, such as a parking lot, a roof, a sidewalk, a driveway, and the like. In the embodiments shown in FIGS. 6-8, the panels 14 may be adapted to a plurality of supports 24, such as the cantilevered trusses shown overhanging the surface of a parking lot 32. One or more panels, or interconnected panels may be formed as a sheet 36 that may be selectively deployed on the supports 24. The sheet 36 may be deployed via a cable that may extend and retract the sheet 36 in an accordion fold. The sheet 36 may also be selectively deployed by a rolling mechanism 40. The sheet 36 may also be selectively deployed by a combination of rolling and folding.

The rolling mechanism 40 may include a roller 40 operatively connected to a drive motor to rotate the roller 40 for extension and retraction of the sheet 36. The drive motor may include a chain drive, a worm screw drive, or a gear driven mechanism, and associated cables and pulleys.

In a preferred embodiment, shown in reference to FIGS. 9-11, the rolling mechanism 40 may include a hydraulic motorized pulley having a cylinder 40 driven by a hydraulic motor 44 contained within the roller 40. The rolling mechanism 40 may be supported on its ends via a pillow block 42. An example of such a hydraulic motorized pulley, is the Tech-Roll, manufactured by Tech-Roll, Inc. of Blaine, Wash. For larger applications, the Heavy Duty or Standard duty models may be suitable. For smaller applications of the sheet 36, the Mini model may be suitable.

When no frozen precipitation events are forecast, the sheet 36 may be retracted to protect the sheet 36 from damage due to impacts from falling debris or deterioration by exposure to sunlight and other environmental hazards. When a precipitation event is forecast, the sheet 36 may be deployed to an extended position to shield the underlying surface 32 from the precipitation, thereby preventing accumulation on the surface 32. Once deployed the circuitry in the controller 12 will selectively heat the panel 36 to melt any falling frozen precipitation. The water may then be carried via a drainage system, such as gutters, drainpipes, the like. The water may them be conveyed to a rainwater collection system, such as a retention pond or sewer drain system in order to carry the water away from the protected surface 32.

In other applications, the present invention can also be utilized to dissipate cold air around doors and windows. This solution will work in multiple applications including but not limited to: panels for driveways, walkways and entryways, roofing Tarps/Fabrics, Drapes and Door/Window skirts. When the invention is installed either in the Driveway or Walkway or Window or at a Door. It is then plugged into a power source, when the snow falls—the product prevents the accumulation of snow and prevents/limits Cold Drafts from entering the Building.

It should be understood, of course, that the foregoing relates to exemplary embodiments of the invention and that modifications may be made without departing from the spirit and scope of the invention as set forth in the following claims.

What is claimed is:

1. A heating panel, comprising:
an electrically conductive mesh formed of a metalized fabric yarn;
a flexible heat conductive layer enclosing the mesh;
a plurality of connectors electrically connected to the conductive mesh in a spaced apart relation around a peripheral edge of the panel.

2. The eating panel of claim 1, wherein the plurality of connectors are integrally formed in the flexible heat conductive layer around a peripheral edge of the panel and are in electrical communication with the conductive mesh.

3. The heating panel of claim 2, further comprising a plurality of female connectors may be formed along a first and second adjacent edge of the panel in a spaced apart relation.

4. The heating panel of claim 3, further comprising a plurality of male connectors may be formed along a third and fourth adjacent edge in a matching spaced apart relation to the female connectors.

5. The heating panel of claim 4, further comprising:
a plurality of panels, electrically interconnected via cooperative engagement of the male connectors and the female connectors.

6. The heating panel of claim 5, wherein the connector is a USB connector.

7. The heating panel system, comprising:
a thermal panel comprising:
an electrically conductive mesh formed of a metalized fabric yarn;
a flexible heat conductive layer enclosing the mesh;
a plurality of connectors electrically connected to the conductive mesh in a spaced apart relation around a peripheral edge of the panel;
a controller electrically coupled to the electrically conductive mesh, the controller comprising circuitry operable to selectively connect an electrical current to the electrically conductive mesh.

8. The heating panel system of claim 7, further comprising:
means for selectively deploying and retracting the thermal panel and configured to cover a selected surface in a deployed condition.

9. The heating panel system of claim 8, wherein the means for selectively deploying and retracting the thermal panel comprises
a cable mechanism.

10. The heating panel system of claim 8, wherein the means for selectively deploying and retracting the thermal panel comprises
a roller mechanism.

11. The heating panel system of claim 10, further comprising:
a drainage system configured to convey a quantity of melted precipitation to a containment system.
